(19) United States
(12) Patent Application Publication
(10) Pub. No.: US 2025/0285044 A1
(43) Pub. Date: Sep. 11, 2025

(54) SINGLE OPERATION IDENTIFICATION

(71) Applicant: Capital One Services, LLC, McLean, VA (US)

(72) Inventors: Bryan TAMAYO, Allen, TX (US); Dale IANNUZZI, Celina, TX (US)

(21) Appl. No.: 18/600,307

(22) Filed: Mar. 8, 2024

(51) Int. Cl. G06Q 10/0631

(52) U.S. Cl. CPC G06Q 10/06311; G06Q 10/06316

(57) ABSTRACT

In some implementations, a system may obtain operation data associated with a plurality of operations assigned to a user. The system may compute a plurality of operation metrics based on the operation data, each operation metric in the plurality of operation metrics corresponding to a respective operation in the plurality of operations. The system may identify a single operation of the plurality of operations based on the plurality of operation metrics. The system may cause a user interface to be displayed, wherein the user interface includes an indication of the single operation, wherein the user interface does not include an indication associated with any other operation from the plurality of operations.

### BACKGROUND

An operation management tool is a tool that allows a user to, for example, organize and track operations assigned to the user. A conventional operation management tool may include features such as creating operations, setting deadlines for operations, assigning operations to specific users, categorizing operations, and/or tracking progress of operations.

### SUMMARY

Some implementations described herein relate to a system for single operation identification. The system may include one or more memories and one or more processors communicatively coupled to the one or more memories. The one or more processors may be configured to obtain operation data associated with a plurality of operations assigned to a user. The one or more processors may be configured to compute a plurality of operation metrics based on the operation data, each operation metric in the plurality of operation metrics corresponding to a respective operation in the plurality of operations. The one or more processors may be configured to identify, based on the plurality of operation metrics, a single operation of the plurality of operations. The one or more processors may be configured to provide information associated with the identified single operation for display via a user interface, wherein information associated with other operations from the plurality of operations is absent from the user interface.

Some implementations described herein relate to a method for single operation identification. The method may include obtaining, by a system, operation data associated with a plurality of operations assigned to a user. The method may include computing, by the system, a plurality of operation metrics based on the operation data, each operation metric in the plurality of operation metrics corresponding to a respective operation in the plurality of operations. The method may include identifying, by the system, a single operation of the plurality of operations based on the plurality of operation metrics. The method may include causing, by the system, a user interface to be displayed, wherein the user interface includes an indication of the single operation, wherein the user interface does not include an indication associated with any other operation from the plurality of operations.

Some implementations described herein relate to a non-transitory computer-readable medium that stores a set of instructions. The set of instructions, when executed by one or more processors of a system, may cause the system to obtain operation data associated with a plurality of operations assigned to a user. The set of instructions, when executed by one or more processors of the system, may cause the system to compute, based on the operation data, a plurality of operation metrics, each operation metric in the plurality of operation metrics being associated with a respective operation in the plurality of operations. The set of instructions, when executed by one or more processors of the system, may cause the system to select a single operation of the plurality of operations based on the plurality of operation metrics. The set of instructions, when executed by one or more processors of the system, may cause the system to provide a user interface for display, wherein the user interface includes information associated with the selected single operation and does not include information associated with any other operations from the plurality of operations.

### BRIEF DESCRIPTION OF THE DRAWINGS

FIGS. 1A-1B are diagrams of an example associated with single operation identification, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with single operation identification, in accordance with some embodiments of the present disclosure.

FIG. 4 is a flowchart of an example process associated with single operation identification, in accordance with some embodiments of the present disclosure.

### DETAILED DESCRIPTION

The following detailed description of example implementations refers to the accompanying drawings. The same reference numbers in different drawings may identify the same or similar elements.

A conventional operation management tool enables a user to organize and track operations assigned to the user (e.g., tasks to be completed by the user). However, conventional operation management tools lack functionality to identify an order in which a group of operations should be performed by the user, and to present such information the user. That is, conventional operation management tools do not provide single operation isolation-identification and presentation of a single (e.g., highest priority) operation that should be the next operation completed by the user.

This lack of functionality in conventional operation management tools causes operations assigned to a given user to be performed out of sequence (e.g., a user may attempt to perform an operation before completing another operation on which the operation depends) and/or to be performed inefficiently (e.g., a less urgent operation may be performed before a more urgent operation is performed). As a result, resources used in association with operation management or actual performance of operations are wasted and/or otherwise used inefficiently. For example, an operation that is performed out-of-sequence and/or in a sub-optimal order with respect to other operations can result in computing resources (e.g., processor resources, memory resources, or the like) and/or network resources (e.g., network bandwidth, radio resources, or the like) being wasted when, for example, the operation needs to be performed a second time as a result of being performed out-of-sequence or at a sub-optimal time (e.g., too early).

Some implementations described herein provide techniques and apparatuses for single operation identification. In some implementations, an operation management system may obtain operation data associated with a plurality of operations assigned to a user. The operation management system may compute a plurality of operation metrics based on the operation data, with each operation metric in the plurality of operation metrics corresponding to a respective operation in the plurality of operations. The operation management system may identify, based on the plurality of operation metrics, a single operation of the plurality of operations. The operation management system may then provide information associated with the identified single operation for display via a user interface, while information associated with other operations from the plurality of operations is absent from the user interface.

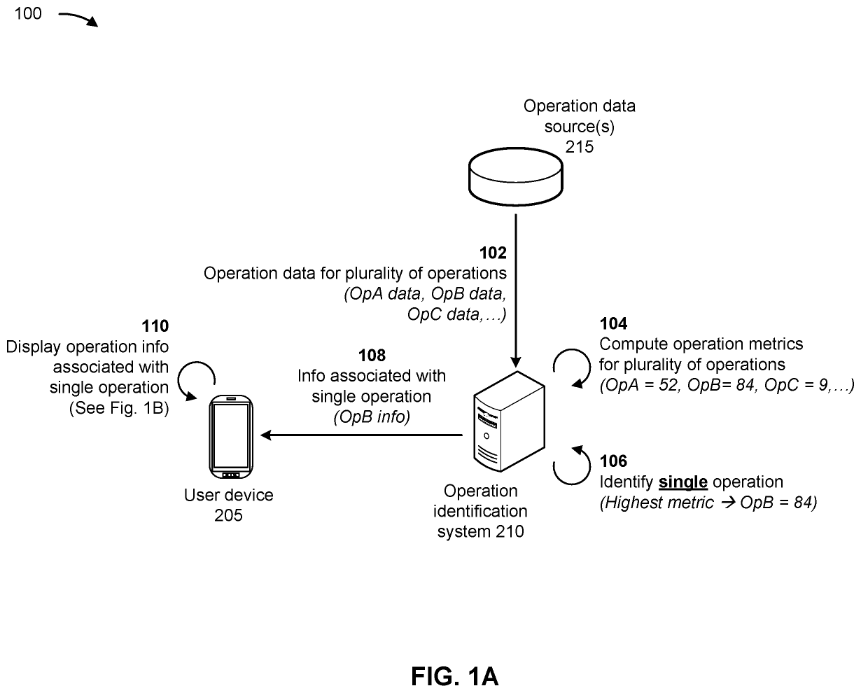

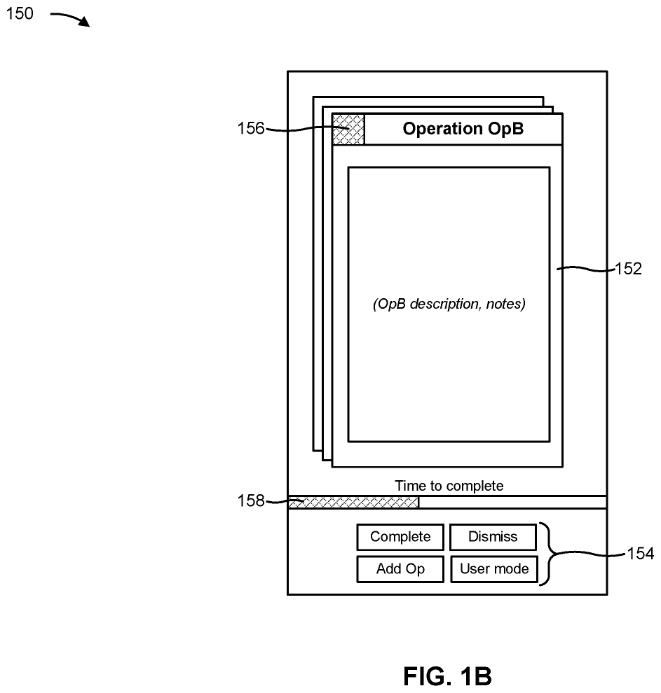

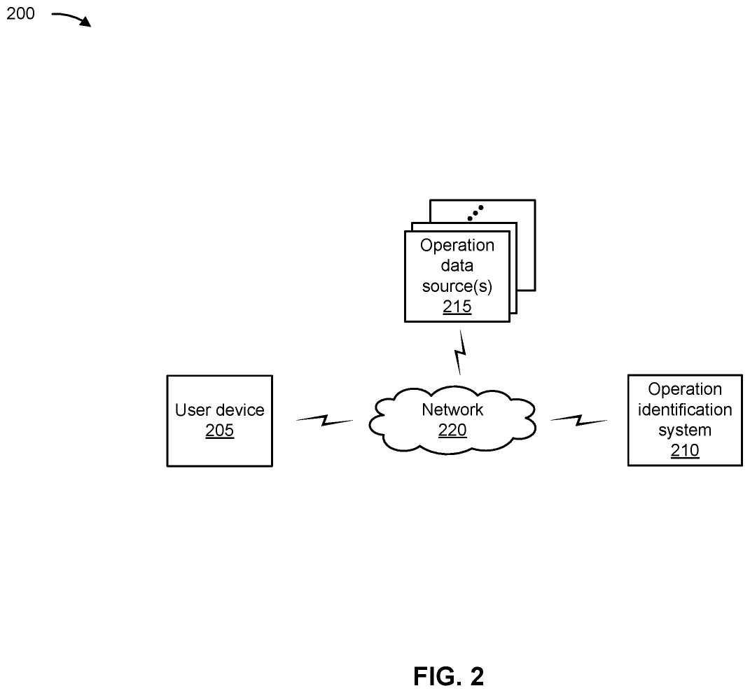

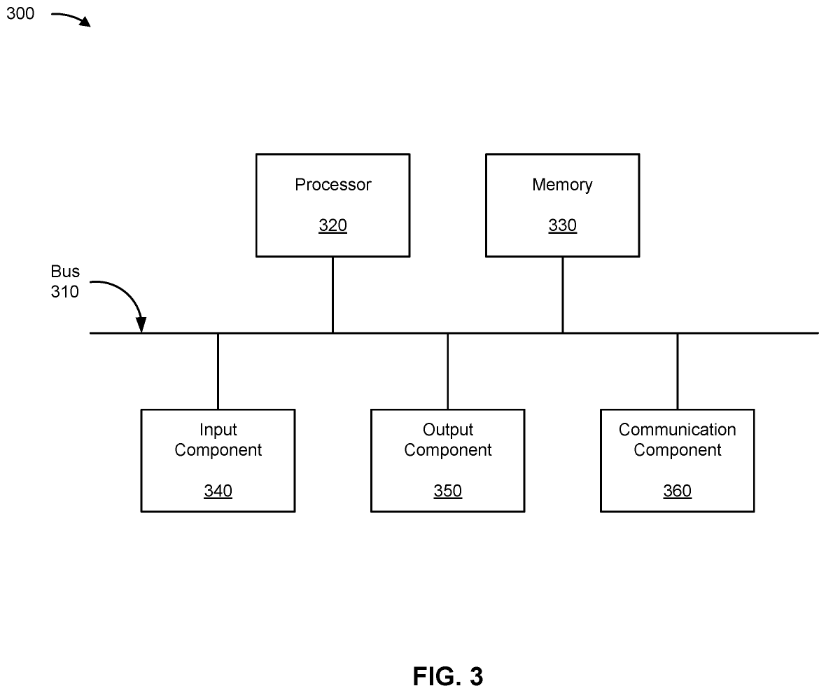

FIGS. 1A-1B are diagrams of examples associated with single operation identification. As shown in FIG. 1A, an example 100 includes a user device 205, an operation identification system 210, and one or more operation data sources 215. These devices are described in more detail in connection with FIGS. 2 and 3.

As shown in FIG. 1A at reference 102, the operation identification system 210 may obtain operation data associated with a plurality of operations assigned to a user. That is, the operation identification system 210 may obtain data associated with a plurality of operations that are assigned to (e.g., to be performed by or completed) a user.

Operation data includes one or more items of information associated with an operation. More particularly, operation data associated with a given operation may include one or more types of information that describe the operation and/or one or more other characteristic of the operation. For example, the operation data may include a title of the operation, a description of the operation (e.g., information that describes what performing the operation is to entail), notes associated with the operation (e.g., notes provided by a user and/or a creator of the operation), or the like). As another example, the operation data may include timing information associated with the operation, such as a date by which the operation is to be completed, a time by which the operation is to be completed, or the like. As another example, the operation data may include a user indication associated with the operation (e.g., an indication of whether the user has previously dismissed or skipped the operation, an indication of a priority of the operation according to the user, or the like). As another example, the operation data may include information that indicates a category associated with the operation. As another example, the operation data may include parent-child information associated with the operation (e.g., information associated with a parent operation of the operation, information associated with other child operations of a parent operation of the operation, information associated with one or more child operations of the operation, information that identifies relationships between the operation and one or more other operations, information that identifies dependencies between the operation and one or more other operations, or the like). As another example, the operation data may include information that indicates a stage associated with the operation (e.g., if the operation is a child operation within a parent operation, the stage may indicate how close the parent operation is to being completed). As another example, the operation data may include information that indicates a duration associated with the operation (e.g., an expected amount of time needed to complete the operation). As another example, the operation data may include information that indicates an age of the operation (e.g., information indicating an amount of time since the operation was assigned to the user or otherwise created). As another example, the operation data may include a label associated with the operation (e.g., a color, a letter, a priority, or the like).

In some implementations, the operation identification system 210 may obtain operation data via user input. For example, the user may provide operation data associated with one or more operations via user input at the user device 205. In one particular example, the user may provide user input via a user interface, displayed on the user device 205, that is to be used for creating an operation. The user device 205 may then provide the operation data to the operation identification system 210 (e.g., automatically upon entry of the operation data or creation of the operation, automatically on a periodic basis, in response to a request from the operation identification system 210, or the like).

In some implementations, the operation identification system 210 may obtain operation data from another system. For example, as illustrated in example 100, the operation identification system 210 may obtain operation data associated with a plurality of operations from an operation data source 215. In some implementations, the operation data source 215 may be a data source that stores or otherwise has access to operation data associated with the user. In some implementations, the operation identification system 210 may obtain one or more items of operation data from via an application programming interface (API) associated with another system (e.g., a system external to the operation identification system 210). In some implementations, the operation identification system 210 may integrate with one or more other tools using, for example, representational state transfer (REST) APIs, a particular query language (e.g., GraphQL), or one or more other tools that facilitate obtaining operation data from an external source (e.g., a third-party service).

In the example 100, the operation identification system 210 receives operation data from one or more operation data sources 215. Here, the operation data includes operation data associated with a plurality of operations-operation data associated with operation OpA, operation data associated with operation OpB, and operation data associated with operation OpC.

As shown at reference 104, the operation identification system 210 may compute a plurality of operation metrics based on the operation data. Here, each operation metric in the plurality of operation metrics may correspond to a respective operation in the plurality of operations. That is, the operation identification system 210 may generate an operation metric for each operation in the plurality of operations, with a given operation metric being generated based on operation data associated with the given operation.

An operation metric is a metric based on which a priority or order (with respect to other operations assigned to the user) can be determined. In some implementations, the determination enabled by the operation metric for a given operation may be a comparative analysis in which an operation metric associated with a given operation is compared to those of other operations in the plurality of operations. In some implementations, an operation metric may be, for example, a numerical value (e.g., a value from 0 to 100, a value from 0.0 to 1.0, or the like), a grade (e.g., a letter grade from A to Z), or another type of metric indicative of a priority or order of operations among the plurality of operations can be determined. In this way, the operation metrics associated with the plurality of operations can enable identification of an order in which operations assigned to the user should be performed, which includes identification of a single (e.g., highest priority) operation assigned to the user.

In some implementations, the operation identification system 210 may generate the plurality of operation metrics using an operation metric model stored or accessible by the operation identification system 210. In some implementations, the operation metric model may be a model trained or otherwise configured to receive one or more items of operation data as input and to provide an operation metric as output. For example, the operation metric model may be configured to receive timing information associated with an operation, a user indication associated with the operation, a category associated with the operation, a stage associated with the operation, parent-child information associated with the operation, a duration associated with the operation, an age associated with the operation, and/or a label associated with the operation as input, and may generate an operation metric in the form of a value between 0 and 100 as an output. In some implementations, the operation metric model may be configured or trained using one or more artificial intelligence (AI) techniques (e.g., machine learning, a convolutional neural network, deep learning, language processing, or the like).

Additionally, or alternatively, the operation identification system 210 may be configured to compute the plurality of operation metrics based on user input indicating a mode associated with the user. The mode associated with the user may indicate a mode in which the user desires to perform tasks, such as a quick-hit mode (e.g., a mode indicating that the user would prefer to perform comparatively shorter operations) or a marathon mode (e.g., a mode indicating that the user would prefer to perform comparatively operations). Thus, in some implementations, the operation identification system 210 may receive (e.g., via the user device 205) user input indicating the mode associated with the user, and may compute the plurality of operation metrics further based on the user indicated mode. In one illustrative example, a quick-hit mode may be associated with a particular value (e.g., +10 “points”). Here, during computation of the plurality of operation metrics, the particular value may be added to a base operation metric computed for each operation that qualifies for the quick-hit mode (e.g., each operation that is expected to take the user less than 30 minutes to complete). In this way, different modes selected by the user can enable operation identification, in part, according to a user desire or preference.

Additionally, or alternatively, the operation identification system 210 may be configured to compute the plurality of operation metrics based on user availability information associated with the user. The user availability information associated with the user includes information that indicates availability of the user at a given time. Thus, in some implementations, the operation identification system 210 may obtain (e.g., via user input, via an operation data source 215, or the like) user availability information associated with the user, and may compute the plurality of operation metrics further based on the user availability information. As one illustrative example, the user availability information may include calendar data associated with the user. Here, the calendar data may indicate an amount of time available for the user to perform tasks until a next engagement (e.g., a next calendar appointment). In this example, the operation identification system 210 may compute the plurality of operation metrics such that one or more operation metrics for operations that can be expected to be completed within the amount of time available until the next engagement are increased relative to operation metrics for operations that cannot be expected to be completed within the amount of time available until the next engagement. In this way, user availability can enable operation identification at a given time so as to increase efficiency with respect to selection of an operation to be performed by the user.

In some implementations, the operation identification system 210 may associate information associated with the user with a given operation metric of the plurality of operation metrics. The information associated with the user may include, for example, a user identifier associated with the user. Additionally, or alternatively, the operation identification system 210 may include information associated with the operation (e.g., an operation identifier) in the operation metric. That is, a given operation metric in the plurality of operation metrics may include an indication of the user and/or the operation with which the given operation metric is associated.

In the example shown in FIG. 1A, the operation identification system 210 computes (e.g., using an operation metric model accessible by the operation identification system 210) a plurality of operation metrics including an operation metric of 52 for operation OpA, an operation metric of 84 for operation OpB, and an operation metric of 9 for operation OpC.

As shown at reference 106, the operation identification system 210 may identify, based on the plurality of operation metrics, a single operation of the plurality of operations. That is, the operation identification system 210 may identify a single (e.g., highest priority) operation based on the plurality of operation metrics. In some implementations, the operation identification system 210 may identify the single operation based on, for example, comparing the plurality of operation metrics to one another and identifying the single operation accordingly. For example, the operation identification system 210 may identify the operation with a highest operation metric value as the single operation.

In the example shown in FIG. 1A, the operation identification system 210 identifies operation OpB as the single operation based on operation OpB having the highest operation metric value of 84.

As shown at reference 108, the operation identification system 210 may provide information associated with the identified single operation for display via a user interface, while information associated with other operations from the plurality of operations is absent from the user interface. For example, the operation identification system 210 may provide, to the user device 205, information associated with the identified single operation for display via the user device 205 and, as shown at reference 110, the user device 205 may provide the user interface for display to the user. Here, the user interface does not include information associated with any other operations in the plurality of operations. That is, the user interface provides information associated with the identified single (e.g., highest priority) operation for display to the user, without displaying information associated with other operations in the plurality of operations. In this way, the operation identification system 210 provides single operation isolation-identification and presentation of a single (e.g., highest priority) operation that should be the next operation completed by the user.

FIG. 1B is a diagram illustrating an abstract example of a user interface 150 comprising information associated with an identified single (e.g., highest priority) operation for display to the user, without displaying information associated with other operations in the plurality of operations. In the example, the user interface comprises a visualization of a stack of operations, with the top “card” 152 in the stack representing the identified single operation. Here, the partially visible cards in the stack represent, for example, that one or more other operations are assigned to the user (without including any information associated with those one or more other operations). As shown, the card 152 may include information associated with the identified single operation, such as a name of the operation (e.g., Operation OpB), a description associated with the identified single operation, notes associated with the identified single operation, or the like. In this way, the user interface may present operations one at a time, which increases a likelihood that operations are performed in-sequence and/or in an optimal order with respect to other operations, thereby reducing waste of computing resources (e.g., processor resources, memory resources, or the like) and/or network resources (e.g., network bandwidth, radio resources, or the like).

As further shown, in this example, the user interface includes one or more input elements 154 (e.g., a plurality of buttons) that enable the user to, for example, indicate that the identified single operation is complete, indicate that the identified single operation is to be dismissed (e.g., such that another operation is identified), add an operation associated with the user (e.g., manually or by importing operation data from another system), or select a mode associated with the user.

As further shown, in this example, the user interface includes an indicator 156 associated with the identified single operation. The indicator may include, for example, a color-coded indicator of an urgency associated with the identified single operation, a category associated with the identified single operation, a priority associated with the identified single operation, or an indication of another type of information associated with the identified single operation.

As further shown, in this example, the user interface includes a countdown timer 158 associated with the identified single operation. Here, the countdown timer 158 may indicate an amount of time (e.g., in minutes, in hours, in days, or the like) remaining until a deadline associated with the identified single operation (e.g., as determined based on the operation data).

In some implementations, the user interface may enable the user to interact with (e.g., click, tap, or the like) the card associated with the identified single operation so that other information associated with the identified single operation is provided for display. For example, clicking or tapping on the card associated with the identified single operation may cause the user device 205 to display a user interface that includes one or more other items of additional information associated with the user interface, such as links to one or more attachments associated with the identified single operation, a dependency path associated with the identified single operation (e.g., information that identifies one or more operations that depend on the operation and/or one or more operations on which the identified single operation depends).

In some implementations, the information provided by the operation identification system 210 may be adaptable for display on multiple types of user devices 205 (e.g., mobile phones, laptops, smart watches, or the like). As such the information provided by the operation identification system 210 may enable a layout of the user interface to be adapted according one or more characteristics (e.g., a screen size, a resolution, or the like) of a given user device 205. Similarly, the information provided by the operation identification system 210 may be provided so as to enable a touchscreen friendly user interface, meaning that the user interface supports touch-based interaction (e.g., a tap, a swipe, or the like).

In some implementations, the user interface may enable the user to manually rearrange operations within the stack. For example, the user interface may enable the user to explode the stack visualization of the plurality of operations and manually rearranged the cards therein. In some implementations, information associated with the rearrangement may be provided to the operation identification system 210 to enable the operation metric model to be adapt to user behavior and improve operation metric computation over time. In general, the use of single operation isolation can enable the operation identification system 210 to adapt to user behavior and improve over time.

Notably, the example shown and described with respect to FIG. 1B is provided as an example for illustrative purposes, and other examples are possible.

In some implementations, the operation identification system 210 may update the user interface to include information associated with a second single operation identified by the operation identification system 210. For example, the operation identification system 210 may receive, via user input at the user interface, an indication that a second single operation (e.g., a next single operation) is to be identified (or selected). The indication may be, for example, an indication that the first identified single operation has been completed (e.g., indicated by tapping a button on the user interface), an indication that the first identified single operation is to be temporarily dismissed (e.g., indicated by a swipe on the user interface), or another type of indication. The operation identification system 210 may then identify (or select) a second single operation of the plurality of operations based on the plurality of operation metrics. As one example, the operation identification system 210 may identify (or select) the operation with a second highest operation metric value as the second single operation. The operation identification system 210 may then provide information associated with the identified (or selected) second single operation for display via an updated user interface. Here, information associated with other operations from the plurality of operations is absent from the updated user interface (e.g., such that the second identified single operation is the only operation explicitly identified on the updated user interface).

In some implementations, the operation identification system 210 may provide information associated with an updated identified single operation for display via an updated user interface. For example, the operation identification system 210 may obtain updated operation data associated with the plurality of operations assigned to the user. Here, the updated operation data may include, for example, operation data associated with one or more new operations (e.g., one or more operations newly assigned to the user) or updated operation data associated with one or more operations of the plurality of operations (e.g., the plurality of operations already assigned to the user). In some implementations, the updated operation data may comprise, for example, additional data associated with a given operation (e.g., an indication that the user has dismissed the operation) or modified data associated with a given operation (e.g., an updated due date). The operation identification system 210 may then compute a plurality of updated operation metrics based on the updated operation data, and identify an updated single operation based on the plurality of updated operation metrics (e.g., an operation with a highest operation metric score after the updated computation). The operation identification system 210 may then provide information associated with the identified updated single operation for display via an updated user interface, while information associated with other operations from the plurality of operations is absent from the updated user interface.

In some implementations, the operation identification system 210 may be utilized in the context of task management of tasks assigned to a user. In other example, the operation identification system 210 may be used to improve efficiency of user interaction at, for example, a brick-and-mortar retail entity. In such a case, the operation identification system 210 may obtain operation data comprising a list of items (e.g., a shopping list), in-store location data associated with items on the items (e.g., via an API associated with the retail entity), and other data. The operation identification system 210 may then compute operation metrics for each operation (i.e., each item to be obtained) and may identify a single operation (e.g., a next item for the user to obtain while navigating the store) based on the operation metrics. In this way, the operation identification system 210 may provide an efficient path for the user to obtain items from the list of items, one item at a time. Such functionality is enabled since the operation identification system 210 would have knowledge that a given single operation is complete (e.g., that a given item has been obtained).

As indicated above, FIGS. 1A-1B are provided as an example. Other examples may differ from what is described with regard to FIGS. 1A-1B.

FIG. 2 is a diagram of an example environment 200 in which systems and/or methods described herein may be implemented. As shown in FIG. 2, environment 200 may include a user device 205, an operation identification system 210, one or more operation data sources 215, and a network 220. Devices of environment 200 may interconnect via wired connections, wireless connections, or a combination of wired and wireless connections.

The user device 205 may include one or more devices capable of receiving, generating, storing, processing, and/or providing information associated with single operation identification, as described elsewhere herein. The user device 205 may include a communication device and/or a computing device. For example, the user device 205 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The operation identification system 210 includes one or more devices capable of receiving, generating, storing, processing, providing, and/or routing information associated with single operation identification, as described elsewhere herein. In some implementations, the operation identification system 210 or one or more components of the operation identification system 210 may include computing hardware used in a cloud computing environment.

In some implementations, one or more components of the operation identification system 210 may be integrated in the user device 205. An implementation in which the operation identification system 210 is integrated in the user device 205 provides increased security for data associated with the user since operation data associated with the user, and other information associated with operations assigned to the user, need not be transmitted over the Internet. Additionally, or alternatively, one or more components of the operation identification system 210 may be separate from the user device 205. An implementation in which the operation identification system 210 is separate from the user device 205 reduces resource usage at the user device 205 (e.g., since computation and processing is performed external to the user device 205).

An operation data source 215 may include one or more devices capable of receiving, generating, storing, processing, and/or providing information (e.g., data) associated with single operation identification, as described elsewhere herein. The operation data source 215 may include a communication device and/or a computing device. For example, the operation data source 215 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. In some implementations, the operation data source 215 may include one or more databases.

The network 220 may include one or more wired and/or wireless networks. For example, the network 220 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 220 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with single operation identification. The device 300 may correspond to user device 205, operation identification system 210, and/or operation data source 215. In some implementations, user device 205, operation identification system 210, and/or operation data source 215 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

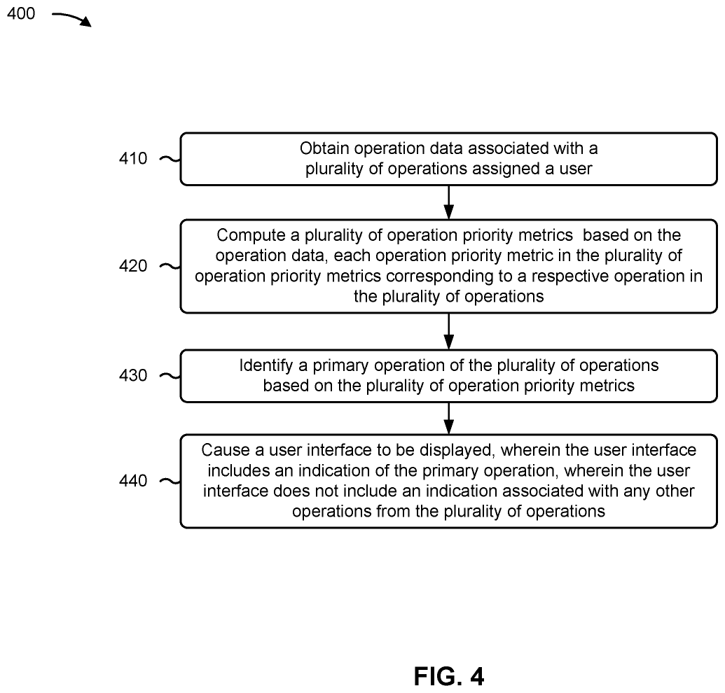

FIG. 4 is a flowchart of an example process 400 associated with single operation identification. In some implementations, one or more process blocks of FIG. 4 may be performed by the operation identification system 210. In some implementations, one or more process blocks of FIG. 4 may be performed by another device or a group of devices separate from or including the operation identification system 210, such as the user device 205. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining operation data associated with a plurality of operations assigned to a user (block 410). For example, the operation identification system 210 (e.g., using processor 320 and/or memory 330) may obtain operation data associated with a plurality of operations assigned to a user, as described above in connection with reference number 102 of FIG. 1A. As an example, the operation identification system 210 may receive operation data from one or more operation data sources 215, with the operation data including operation data associated with a plurality of operations-operation data associated with operation OpA, operation data associated with operation OpB, and operation data associated with operation OpC.

As further shown in FIG. 4, process 400 may include computing a plurality of operation metrics based on the operation data, each operation metric in the plurality of operation metrics corresponding to a respective operation in the plurality of operations (block 420). For example, the operation identification system 210 (e.g., using processor 320 and/or memory 330) may compute a plurality of operation metrics based on the operation data, each operation metric in the plurality of operation metrics corresponding to a respective operation in the plurality of operations, as described above in connection with reference number 104 of FIG. 1A. As an example, the operation identification system 210 may compute (e.g., using an operation metric model accessible by the operation identification system 210) a plurality of operation metrics including an operation metric of 52 for operation OpA, an operation metric of 84 for operation OpB, and an operation metric of 9 for operation OpC.

As further shown in FIG. 4, process 400 may include identifying a single operation of the plurality of operations based on the plurality of operation metrics (block 430). For example, the operation identification system 210 (e.g., using processor 320 and/or memory 330) may identify a single operation of the plurality of operations based on the plurality of operation metrics, as described above in connection with reference number 106 of FIG. 1A. As an example, the operation identification system 210 may identify operation OpB as the single operation based on operation OpB having the highest operation metric value of 84.

As further shown in FIG. 4, process 400 may include causing a user interface to be displayed, wherein the user interface includes an indication of the single operation, wherein the user interface does not include an indication associated with any other operation from the plurality of operations (block 440). For example, the operation identification system 210 (e.g., using processor 320 and/or memory 330) may cause a user interface to be displayed, wherein the user interface includes an indication of the single operation, wherein the user interface does not include an indication associated with any other operation from the plurality of operations, as described above in connection with reference number 108 of FIG. 1A. As an example, the operation identification system 210 may provide information associated with the operation OpB for display via a user interface, with the user interface including information associated with only with OpB (e.g., such that the user interface does not include information associated with operation OpA or information associated with operation OpC).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1B. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for single operation identification, the system comprising:
one or more memories; and
one or more processors, communicatively coupled to the one or more memories, configured to:
obtain operation data associated with a plurality of operations assigned to a user;
compute a plurality of operation metrics based on the operation data, each operation metric in the plurality of operation metrics corresponding to a respective operation in the plurality of operations;
identify, based on the plurality of operation metrics, a single operation of the plurality of operations; and
provide information associated with the identified single operation for display via a user interface, wherein information associated with other operations from the plurality of operations is absent from the user interface.

2. The system of claim 1, wherein, for an operation in the plurality of operations, the operation data includes at least one of:
timing information associated with the operation;
a user indication associated with the operation;
a category associated with the operation;
a stage associated with the operation;
parent-child information associated with the operation;
a duration associated with the operation;
an age associated with the operation; or
a label associated with the operation.

3. The system of claim 1, wherein one or more items of the operation data are obtained from another system via an application programming interface (API).

4. The system of claim 1, wherein the one or more processors are further configured to:
receive user input indicating a mode associated with the user; and
wherein the one or more processors, to compute the plurality of operation metrics, are configured to:
compute the plurality of operation metrics further based on the user input indicating the mode associated with the user.

5. The system of claim 1, wherein the one or more processors are further configured to:
obtain user availability information associated with the user; and
wherein the one or more processors, to compute the plurality of operation metrics, are configured to:
compute the plurality of operation metrics further based on the user availability information.

6. The system of claim 1, wherein the one or more processors are further configured to:
receive, via the user interface, an indication that a second single operation is to be identified;
identify, based on the plurality of operation metrics, a second single operation of the plurality of operations; and
provide information associated with the identified second single operation for display via an updated user interface, wherein information associated with other operations from the plurality of operations is absent from the updated user interface.

7. The system of claim 1, wherein the one or more processors are further configured to:
obtain updated operation data associated with the plurality of operations assigned to the user;
compute a plurality of updated operation metrics based on the updated operation data;
identify an updated single operation based on the plurality of updated operation metrics; and
provide information associated with the identified updated single operation for display via an updated user interface, wherein information associated with other operations from the plurality of operations is absent from the updated user interface.

8. A method for single operation identification, comprising:
obtaining, by a system, operation data associated with a plurality of operations assigned to a user;
computing, by the system, a plurality of operation metrics based on the operation data, each operation metric in the plurality of operation metrics corresponding to a respective operation in the plurality of operations;
identifying, by the system, a single operation of the plurality of operations based on the plurality of operation metrics; and
causing, by the system, a user interface to be displayed, wherein the user interface includes an indication of the single operation,
wherein the user interface does not include an indication associated with any other operation from the plurality of operations.

9. The method of claim 8, wherein, for an operation in the plurality of operations, the operation data includes at least one of:
timing information associated with the operation;
a user indication associated with the operation;
a category associated with the operation;
a stage associated with the operation;
parent-child information associated with the operation;
a duration associated with the operation;
an age associated with the operation; or
a label associated with the operation.

10. The method of claim 8, wherein one or more items of the operation data are obtained from another system via an application programming interface (API).

11. The method of claim 8, further comprising:
receiving user input indicating a mode associated with the user; and
wherein computing the plurality of operation metrics comprises:
computing the plurality of operation metrics further based on the user input indicating the mode associated with the user.

12. The method of claim 8, further comprising:
obtaining user availability information associated with the user; and
wherein computing the plurality of operation metrics comprises:
computing the plurality of operation metrics further based on the user availability information.

13. The method of claim 8, further comprising:
receiving, via the user interface, an indication that a next single operation is to be identified;
identifying, based on the plurality of operation metrics, a next single operation of the plurality of operations; and
causing an updated user interface to be displayed, wherein the updated user interface includes an indication of the next single operation and does not include an indication associated with any other operation from the plurality of operations.

14. The method of claim 8, further comprising:
obtaining updated operation data associated with the plurality of operations assigned to the user;
computing a plurality of updated operation metrics based on the updated operation data;
identifying an updated single operation based on the plurality of updated operation metrics; and
causing an updated user interface to be displayed, wherein the updated user interface includes an indication of the updated single operation and does not include an indication associated with any other operation from the plurality of operations.

15. A non-transitory computer-readable medium storing a set of instructions, the set of instructions comprising:
one or more instructions that, when executed by one or more processors of a system, cause the system to:
obtain operation data associated with a plurality of operations assigned to a user;
compute, based on the operation data, a plurality of operation metrics, each operation metric in the plurality of operation metrics being associated with a respective operation in the plurality of operations;
select a single operation of the plurality of operations based on the plurality of operation metrics; and
provide a user interface for display, wherein the user interface includes information associated with the selected single operation and does not include information associated with any other operations from the plurality of operations.

16. The non-transitory computer-readable medium of claim 15, wherein, for an operation in the plurality of operations, the operation data includes at least one of:
timing information associated with the operation;
a user indication associated with the operation;
a category associated with the operation;
a stage associated with the operation;
parent-child information associated with the operation;
a duration associated with the operation;
an age associated with the operation; or
a label associated with the operation.

17. The non-transitory computer-readable medium of claim 15, wherein one or more items of the operation data are obtained from another system via an application programming interface (API).

18. The non-transitory computer-readable medium of claim 15, wherein the one or more instructions further cause the system to:
receive user input indicating a mode associated with the user; and
wherein the one or more instructions, to cause the system to compute the plurality of operation metrics, cause the system to:
compute the plurality of operation metrics further based on the user input indicating the mode associated with the user.

19. The non-transitory computer-readable medium of claim 15, wherein the one or more instructions further cause the system to:
obtain user availability information associated with the user; and
wherein the one or more instructions, to cause the system to compute the plurality of operation metrics, cause the system to:
compute the plurality of operation metrics further based on the user availability information.

20. The non-transitory computer-readable medium of claim 15, wherein the one or more instructions further cause the system to:
receive, via the user interface, an indication that a second single operation is to be selected;
select, based on the plurality of operation metrics, a second single operation of the plurality of operations; and
provide an updated user interface for display, wherein the updated user interface includes information associated with the selected second single operation and does not include information associated with any other operations from the plurality of operations.
